(19) United States
(12) Patent Application Publication
(10) Pub. No.: US 2017/0251662 A1
(43) Pub. Date: Sep. 7, 2017

(54) ALTERNATIVE DEVICE AND METHODS FOR APPLICATION OF 1-METHYLCYCLOPROPENE TO FRUIT

(71) Applicant: AGROFRESH INC., Collegeville, PA (US)

(72) Inventors: Arden Nathan REED, Wenatchee, WA (US); Dana FAUBION, Yakima, WA (US); Claus DOLPH, Cashmere, WA (US); Fernando EDAGI, Wenatchee, WA (US)

(21) Appl. No.: 15/452,506

(22) Filed: Mar. 7, 2017

Related U.S. Application Data
(60) Provisional application No. 62/304,651, filed on Mar. 7, 2016.

(51) Int. Cl. A01N 27/00

(52) U.S. Cl. CPC A01N 27/00; B05B 1/207

(57) ABSTRACT

The present disclosure relates to a device and methods for administering 1-MCP treatment as a substrate to inhibit ripening of agricultural plants and crops, such as fruit.

### CROSS-REFERENCE TO RELATED APPLICATION

This application claims the benefit under 35 USC §119(e) of U.S. Provisional Patent Application Ser. No. 62/304,651, filed on Mar. 7, 2016, the entire disclosure of which is incorporated herein by reference.

### FIELD OF THE PRESENT APPLICATION

The present application relates to a device and methods for administering 1-methylcyclopropene compound to control or inhibit the ripening of fruit crops.

### BACKGROUND

Cyclopropene is an organic compound that is known to have inhibitory effects on the ripening process of plants and crops, such as fruit crops. For example, the cyclopropene derivative, 1-Methylcyclopropene (1-MCP) is used commercially by the food industry to slow the ripening of fruits and vegetables due to exposure to ethylene.

Ethylene is a gas that is known to stimulate or regulate plants processes, including the ripening of fruits. 1-MCP binds to the ethylene receptor and blocks ethylene from initiating and/or speeding the ripening process in fruits, and thus delays or prevents the natural ripening process. Fruit treatments of 1-MCP have been reported to be in many forms, such as a gas or liquid composition that may be applied to fruits by various applications techniques, including spraying, dipping, drenching, vaporizing, and/or misting.

However, some of these treatment methods incorporate the use of 1-MCP compounds that are recycled. In other words, the same 1-MCP formulation is used repeatedly to treat different fruit. Therefore, the use of a recycled 1-MCP treatment may promote the spread of any inoculum that has infected the treatment formulation. For example, a 1-MCP dipping, drenching, or spraying treatment infected with a disease inoculum (e.g., Botrytis or Pencillium spp.) may spread the infection to all fruit treated with the same 1-MCP treatment formulation.

While the commercial fruit industry employs large-scale treatments of 1-MCP to protect fruit crops in large mass, (i.e., storage rooms filled with bins full of fruit comprising over 2,000,000 lbs of fruit), there remains a need for small farmers and growers to have access to the similar treatment methods for their smaller fruit crops sizes. In particular, there remains a need for small growers to employ methods of treating post-harvest fruit crops with 1-MCP in order to protect them from premature ripening during storage and transport. Further, there is a specific need for small growers to protect plants and crops that are not conducive to being treated in the field pre-harvest, the delay in time required to transport fruit from the field to a confined space, and/or being stored in air tight confined spaces.

For example, there is often a delayed exposure to a ripening inhibitor after fruits have been harvested. Typically, fruits are tied up for an initial time period prior to a ripening inhibitor treatment. In addition, fruit application times for typical ripening inhibitor treatment may range from several hours to a couple of days (e.g., from about 2 hours to about 24 hours). In the industry, a minimum volume of fruit is required at the beginning and end of harvest in order to cost effectively apply a ripening inhibitor treatment, such as 1-MCP. Thus, collection of a sufficient quantity of fruit is necessary to make treatment application in a gas tight room efficient and cost effective. Otherwise, 1-MCP treatment applications might be delayed until the amount of post-harvest fruit reaches critical mass in order to efficiently and economically treat fruits. Once applied the active ingredient (i.e., 1-MCP) inhibits the normal ethylene ripening pathway which is responsible for senescence.

The present disclosure describes a device and methods of treating small quantities of horticultural plants and crops with compositions of 1-MCP. More specifically, the present disclosure provides a device and methods for treating post-harvest fruit crops with a liquid composition of 1-MCP in order to protect them from premature ripening prior to storage or transport. The present disclosure demonstrates that a quick post-harvest liquid treatment application of a ripening inhibitor, such as 1-MCP, overcomes the time delay of treatment that typically occurs between harvest and treatment, the spread of infection to fruit, and also reduces the number or amount of fruit that is required to make application of the 1-MCP treatment economically feasible. In addition, the present disclosure is directed to a device and methods that do not require a confined space to treat the plant or fruit crops with a ripening inhibitor agent.

Ultimately, the device and methods described herein provide new treatment options and application systems for small growers and producers to preserve the freshness of post-harvest plants and crops by delaying premature ripening. Furthermore, the device and methods of the present disclosure advantageously protect plants and crops that are not conducive to being treated in the field pre-harvest, waiting for the time required to transport fruit from the field to a confined space, and/or being stored in confined spaces.

### SUMMARY OF THE INVENTION

The present disclosure provides a method of treating plants or plant parts with a ripening inhibitor agent. The method comprises placing the plants or plant parts in a bin, and administering a 1-MCP compound treatment to the plants or plant parts in the bin. Finally, the method provides for delaying the ripening of plants or plant parts. In the method described herein, the plants or plant parts may comprise fruit. For example, fruit of the present method may comprise apples or pears.

In addition, the 1-MCP compound treatment of the present method may be administered to the bin of plants or plant parts as a liquid or using a wand device. The wand device of the present disclosure comprises a sprayer, a shaft, and a hose. The shape of the sprayer of the wand device may be circular or straight.

### BRIEF DESCRIPTION OF THE DRAWINGS

A brief description of the drawings is as follows.

FIG. 1 is a schematic of a wand device of the present invention.

FIG. 2 is an image of an operator using the wand device of the present disclosure to treat apples.

FIG. 3 is a graph showing the firmness of pears treated with a 1-MCP composition of the present disclosure.

FIG. 4 is a graph showing the ethylene content of pears treated with a 1-MCP composition of the present disclosure.

FIG. 5 is a graph showing the color of pears treated with a 1-MCP composition of the present disclosure.

FIG. 6 is a graph showing the firmness of apples treated with a 1-MCP composition of the present disclosure.

FIG. 7 is a graph showing the ethylene content of apples treated with a 1-MCP composition of the present disclosure.

FIG. 8 is an image of an operator using a CO₂ backpack to treat apples.

FIG. 9 is an image of an operator using a BinBong device to treat apples.

FIG. 10 is an image of an operator using a sprayer to treat apples.

FIG. 11 is a graph showing the firmness of melons treated with a 1-MCP composition of the present disclosure and stored for 15 days or more.

FIG. 12 is a graph showing the firmness of melons treated with a 1-MCP composition of the present disclosure and stored for 9 days or more.

### DETAILED DESCRIPTION

The following numbered embodiments are contemplated and are non-limiting:

1. A method of treating small quantities of plants or plant parts with a ripening inhibitor treatment comprising:

placing the plants or plant parts in a bin,

administering a ripening inhibitor treatment comprising a cyclopropene compound to the plants or plant parts in the bin, and

delaying the ripening of the plants or plant parts.

2. The method of clause 1, wherein the plants or plant parts comprise fruit.

3. The method of clause 1 or clause 2, wherein the fruit comprise post-harvest fruit.

4. The method of any one of clauses 1 to 3, wherein the post-harvest fruit comprises apples or pears.

5. The method of any one of clauses 1 to 4, wherein the ripening inhibitor treatment is administered to the bin of plants or plant parts as a liquid, a solid, or a gaseous composition.

6. The method of any one of clauses 1 to 5, wherein the ripening inhibitor treatment is administered to the bin of plants or plant parts as a spray, a mist, a liquid, a gel, a thermal fog, a non-thermal fog, a dip, a drench, a vapor, or a gas.

7. The method of any one of clauses 1 to 6, wherein the ripening inhibitor treatment is administered to the bin of plants or plant parts as a liquid composition.

8. The method of any one of clauses 1 to 7, wherein the ripening inhibitor treatment comprises about between 0.5% to about 50% of the cyclopropene compound.

9. The method of any one of clauses 1 to 8, wherein the cyclopropene compound is 1-methylcyclopropene (1-MCP) or an analog or derivative thereof.

10. The method of any one of clauses 1 to 9, wherein the 1-MCP or analog or derivative thereof comprises the following structure:

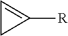

11. The method of clause 10, wherein the R is methyl.

12. The method of any one of clauses 1 to 11, wherein the ripening inhibitor treatment comprises 0.10 g to 1.05 g of 1-MCP compound.

13. The method of any one of clauses 1 to 12, wherein the ripening inhibitor treatment comprises another compound or a carrier.

14. The method of clause 13, wherein the carrier comprises a liquid, a gas, an oil, a solution, a solvent, a solid, a diluent, an encapsulating material, or a chemical.

15. The method of clause 13 to clause 14, wherein the carrier comprises water, saline, a buffer, a solution, or a solvent.

16. The method of any one of clauses 1 to 15, wherein the ripening inhibitor treatment further comprises a component selected from the group consisting of an adjuvant, a surfactant, an excipient, a dispersant, and an emulsifier.

17. The method of clause 16, wherein the amount of the adjuvant, the surfactant, the excipient, the dispersant, and the emulsifier is about 0.001 g/bin in a gas ripening inhibitor treatment.

18. The method of clause 16 or clause 17, wherein the amount of the adjuvant, the surfactant, the excipient, the dispersant, and the emulsifier is about 2 g/bin in a liquid ripening inhibitor treatment.

19. The method of any one of clauses 1 to 18, wherein the bin is sealed.

20. The method of any one of clauses 1 to 19, wherein the bin is semipermeable or impermeable.

21. The method of any one of clauses 1 to 20, wherein the bin is made of a material selected from the group consisting of plastic, glass, and wood.

22. The method of any one of clauses 1 to 21, wherein the one or more plants or plant parts are manually or robotically placed in the bin.

23. The method of any one of clauses 1 to 22, wherein the bin is selected from the group consisting of a wagon, a transport truck cargo area, a cold-storage room, a marine container, an air container, a train car, a local vehicle, a transport truck, a trailer, a box, a pallet-wrap, a greenhouse, and a grain silo.

24. The method of any one of clauses 1 to 23, wherein the bin has a volume ranging from about 50 pounds to about 2000 pounds.

25. The method of any one of clauses 1 to 24, wherein the cyclopropene compound is selected from the group consisting of AFxRD-038, AFx701w, AFx701, and combinations thereof.

26. The method of any one of clauses 1 to 25, wherein the cyclopropene compound comprises about 25 g to about 50 g of AFxRD-038.

27. The method of any one of clauses 1 to 25, wherein the cyclopropene compound comprises about 10 g to about 80 g of AFx701.

28. The method of any one of clauses 1 to 27, wherein the ripening inhibitor treatment is administered to the plants or plant parts at rate a ranging from about 0.1 gal/bin to about 10 gal/bin.

29. The method of any one of clauses 1 to 27, wherein the ripening inhibitor treatment is administered to the plants or plant parts at rate a ranging from about 10 L or less/bin.

30. The method of any one of clauses 1 to 29, wherein the cyclopropene compound is administered as an injection.

31. The method of any one of clauses 1 to 30, wherein the ripening inhibitor treatment comprises about 5 to about 75 mls of cyclopropene compound diluted in about 1 L to about 4 L of water.

32. The method of any one of clauses 1 to 27 and clauses 30 to 31, wherein the ripening inhibitor treatment is administered at a rate of about 100 gal/acres to about 500 gal/acre of plants or plant parts.

33. The method of any one of clauses 1 to 32, wherein the ripening inhibitor treatment is not recycled.

34. The method of any one of clauses 1 to 33, wherein the timing of administering the ripening inhibitor treatment overcomes the time delay between harvest of the plant and plant parts to treatment of the plant and plant parts.

35. The method of any one of clauses 1 to 34, wherein the time delay between harvest of the plant and plant parts to treatment of the plant and plant parts comprises transport of the plant or plant parts from a field to a confined space.

36. The method of any one of clauses 1 to 35, wherein the method is effective in reducing the spread of infection and disease among the plants or plant parts.

37. The method of any one of clauses 1 to 36, wherein the method reduces the minimal number of plants or plant parts required for the ripening inhibitor treatment to be economically feasible.

38. The method of any one of clauses 1 to 37, wherein administering the ripening inhibitor treatment does not require a confined space.

39. The method of any one of clauses 1 to 4 and clauses 8 to 38, wherein administering the ripening inhibitor treatment to the bin of plants or plant parts comprises release of the cyclopropene compound from a sachet, a synthetic film, a natural film, a liner, a gas-releasing generator, a compressed cylinder, a non-compressed gas cylinder, or a droplet inside a box.

40. The method of any one of clauses 1 to 39, wherein administering the ripening inhibitor treatment is performed using a wand device.

41. A wand device adapted to perform the method of any one of clauses 1 to 40, wherein the wand device comprises:

one or more sprayers located at the proximal end of the wand device,

one or more hoses located at the distal end of the wand device,

a shaft that connects the one or more sprayers to the one or more hoses, and

the ripening inhibitor treatment.

42. The wand device of clause 41, wherein the sprayer, the shaft, and the hose each comprise an internal duct through which the ripening inhibitor treatment flows.

43. The wand device of clause 42, wherein the internal duct has a diameter that ranges from about 1 mm to about 6 mm.

44. The wand device of any one of clauses 41 to 43, wherein the shape of the one or more sprayers is circular or straight.

45. The wand device of clause 44, wherein the one or more sprayers is circular, and wherein the sprayer has a diameter between about 6 inches to about 4 feet.

46. The wand device of clause 44, wherein the one or more sprayers is straight, and wherein the sprayer has a length between about 2 feet to about 10 feet.

47. The wand device of any one of clauses 41 to 46, wherein the one or more sprayers comprise one or more orifices through which the ripening inhibitor treatment is released.

48. The wand device of clause 47, wherein the one or more orifices are located around the circumference of a single side of the sprayer.

49. The wand device of any one of clauses 41 to 48, wherein the sprayer comprises about 4 orifices to about 20 orifices.

50. The wand device of any one of clauses 47 to 49, wherein the distance between the one or more orifices is between about 1 cm to about 4 cm.

51. The wand device of any one of clauses 41 to 50, wherein the shaft connects the distal end of the sprayer to the proximal end of the hose.

52. The wand device of any one of clauses 41 to 51, wherein the shaft has a length ranging from about 2 feet to about 6 feet.

53. The wand device of any one of clauses 41 to 52, wherein the one or more hoses connects the shaft to one or more tanks.

54. The wand device of clause 53, wherein the one or more tanks comprise the ripening inhibitor treatment or components of the ripening inhibitor treatment.

55. The wand device of clause 54, wherein the components of the ripening inhibitor treatment flow from the one or more tanks through the one or more hoses and into the shaft.

56. The wand device of any one of clauses 54 or clause 55, wherein the components of the ripening inhibitor treatment are combined in the shaft to form the ripening inhibitor treatment.

57. The wand device of any one of clauses 53 to 56, wherein the one or more tanks comprise a pressurized water source.

58. The wand device of clause 57, wherein the one or more hoses connected to the one or more tanks comprising the pressurized water source further comprise a pump.

59. The wand device of any one of clauses 41 to 58, wherein the wand device is connected to a CO₂ backpack.

60. The wand device of clause 59, wherein the wand device is connected to the CO₂ backpack by one or more hoses.

61. The wand device of any one of clauses 41 to 58, wherein the wand device is held by a stationary piece of equipment.

62. The wand device of any one of clauses 41 to 61, wherein the bin of plants or plant parts is placed under or through the wand device for treatment.

63. The wand device of any one of clauses 41 to 62, wherein the wand device enables uniform administration of the ripening inhibitor treatment to plants or plant parts.

64. A method of administering a ripening inhibitor treatment to small quantities of plants or plant parts according to the method of clause 1, said method comprising:

placing the plants or plant parts in the bin for a treatment time period,

wherein the bin has a temperature and an atmosphere to which plants and plant parts are exposed during the treatment time period,

administering a ripening inhibitor treatment comprising 1-MCP to the plants or plant parts in the bin during the treatment time period.

65. The method of clause 64, wherein the treatment time period is between about 3 seconds to 30 minutes.

66. The method of clause 64 or clause 65, wherein the treatment time period comprises a time period selected from the group consisting of a first time period, a second time period, a third time period, a fourth time period, a fifth time period, or any combination thereof.

67. The method of clause 66, wherein the first time period is between about 1 minute to 5 days.

68. The method of clause 66 or clause 67, wherein the temperature during the first time period ranges from about 20° C. to about 25° C.

69. The method of any one of clauses 66 to 68, wherein the plants and plant parts are dried after expiration of the first time period.

70. The method of clause 69, wherein the plants or plants parts are dried by air or by heat.

71. The method of any one of clause 69 or clause 70, wherein plants or plants parts are dried by heat comprising air at room temperature or higher.

72. The method of any one of clauses 69 to 71, wherein the plants or plants parts are dried in the bin, in a confined space, or outside.

73. The method of clause 66, wherein the second time period is between about 12 hours to 5 days.

74. The method of clause 66 or clause 73, wherein the temperature during the second time period is room temperature or higher.

75. The method of clause 66, wherein the third time period is between about 12 hours to 90 days.

76. The method of clause 66 or clause 75, wherein the temperature during the third time period ranges from about 2° C. to about 10° C.

77. The method of clause 66, wherein the fourth time period is between about 12 hours to 15 days.

78. The method of clause 66 or clause 77, wherein the temperature during the fourth time period is room temperature or higher.

79. The method of any one of clauses 66, clause 77, or clause 78, wherein approximately 100 to 400 plants and plant parts are removed from the bin after expiration of the fourth time period and placed into a sampling container.

80. The method of clause 79, wherein the plants and plant parts are removed from the top of each bin, layer by layer, and placed into the sampling container.

81. The method of clause 79 or clause 80, wherein the sampling container is plastic.

82. The method of any one of clauses 79 to 81, wherein the plants and plant parts in the sampling container are stored for the fifth time period.

83. The method of clause 66 or clause 82, wherein the fifth time period is between about 12 hours to 20 days.

84. The method of any one of clauses 66, 82, or 83, wherein the temperature during the fifth time period is room temperature or higher.

85. The method of any one of clauses 66 or clauses 82 to 84, wherein the plants and plant parts are assessed during the fifth period.

86. The method of any one of clauses 66 or clauses 82 to 85, wherein the plants and plant parts are assessed after expiration of the fifth period.

87. The method of any one of clauses 64 to 86, wherein the atmosphere of the bin is a controlled atmosphere.

88. The method of any one of clauses 64 to 86, wherein the atmosphere of the bin is a regular atmosphere.

89. The method of any one of clauses 64 to 86 or clause 88, wherein the regular atmosphere of the bin comprises a temperature of 4° C.

90. The method of clause 88 or clause 89, wherein the regular atmosphere of the bin comprises about 20% O₂, about 78% N₂, and about 1% CO₂.

The terms “plant(s)” and “plant parts” include, but not limited to, whole plants, plant cells, and plant tissues, such as leaves, calli, stems, pods, roots, fruits, flowers, pollen, and seeds. A class of plants that may be used in the present invention is generally as broad as the class of higher and lower plants including, but not limited to, dicotyledonous plants, monocotyledonous plants, agronomic crops, and horticultural crops. Agronomic crops include, but are not limited to, horticultural crops. Horiticultural crops include, but are not limited to, vegetable crops, fruit crops, edible nuts, flowers and ornamental crops, nursery crops, aromatic crops, and medicinal crops.

More specifically, horticultural crops of the present disclosure include, but are not limited to, fruit selected from, but not limited to, almond, apple, avocado, banana, berries (including strawberry, blueberry, raspberry, blackberry, currents and other types of berries), carambola, cherry, citrus (including orange, lemon, lime, mandarin, grapefruit, and other citrus), coconut, fig, grape, guava, kiwifruit, mango, nectarine, melons (including cantaloupe, muskmelon, watermelon, honeydew, and other melons), olive, papaya, passionfruit, peach, pear, persimmon, pineapple, plum, and pomegranate. In particular, fruits (e.g., grapes, apples, pears, persimmons, and bananas) and berries (e.g., strawberries, blackberries, blueberries, and raspberries) are plants encompassed by the present disclosure. However, it should be noted that any variety or cultivar of berries or fruits may be used in the present invention

The terms “plant material” or “plant part” include, but are not limited to, leaves, calli, stems, roots, flowers or flower parts, fruits, pollen, egg cells, zygotes, seeds, cuttings, cell or tissue cultures, or any other part or product of a plant. In one embodiment, plant material or plant part includes cotyledon and leaf. In another embodiment, plant material or plant part includes root tissues and other plant tissues located underground.

### Compounds and Components of the Present Methods

The methods of the present disclosure are directed to using cyclopropene compounds to treat horticultural plants and crops, such as fruit crops. The methods of the present disclosure to treat plant or plant parts comprise, consist essentially of, or consist of 1-Methylcyclopropene (1-MCP) compounds.

Exemplary embodiments of the compounds of the present disclosure comprise 1-Methylcyclopropene (1-MCP), which may encompass diastereomers and enantiomers of the illustrative compounds. Enantiomers are defined as one of a pair of molecular entities which are mirror images of each other and non-superimposable. Diastereomers or diastereoisomers are defined as stereoisomers other than enantiomers. Diastereomers or diastereoisomers are stereoisomers not related as mirror images. Diastereoisomers are characterized by differences in physical properties.

One exemplary embodiment of a 1-MCP compound of the present method is:

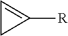

or an analog or derivative thereof. In an exemplary embodiment, R is methyl. 1-MCP may be used individually or as a mixture or combination with another compound or carrier. For example, the 1-MCP compound may also be used in combination with a carrier to form a 1-MCP treatment. The 1-MCP active ingredient in the treatment of the present disclosure comprises, consists of, or consists essentially of about 0.5% to about 50% active ingredient in the product. The 1-MCP treatment provides protection to plants or crops from premature ripening when the treatment is administered, applied, or exposed to the plant or crops.

1-MCP may be used in any form, including, but not limited to, a liquid, a solid (e.g., a powder), or a gaseous composition. In particular, the present method provides application of a 1-MCP compound as a spray, a mist, a gel, a thermal and non-thermal fog, a dip or a drench, or via sublimation, a vapor, or a gas. In an exemplary spraying application, a CO₂ backpack may be used to spray the 1-MCP treatment onto the plants or fruit crops. Additional examples of 1-MCP treatment administration include, but are not limited to, release from a sachet, a synthetic or natural film, a liner or other packaging materials, a gas-releasing generator, compressed or non-compressed gas cylinder, a droplet inside a box, or other similar methods.

Carriers of the present disclosure are materials or compositions involved in carrying or transporting an active ingredient, compound, analog, or derivative from one location to another location. Carriers may be combined with active 1-MCP compounds to form a 1-MCP treatment. Treatment carriers of the present disclosure may comprise liquids, gases, oils, solutions, solvents, solids, diluents, encapsulating materials, or chemicals. For example, a liquid carrier of the present disclosure may comprise water, buffer, saline solution, a solvent, etc. In addition to carriers, other components may be comprised in the treatment of the present disclosure including, but not limited to adjuvants, surfactants, excipients, dispersants, emulsifiers, etc. Such other components may be comprised in the 1-MCP treatment in the range of about 0.001 grams/bin of SmartFresh post-harvest gas treatment to about 2.0 grams/bin of Harvista pre-harvest liquid treatment.

The active 1-MCP compounds of the present disclosure may be applied to plants or crops, such as fruit crops in a volume of a chamber or bin. A chamber or bin of the present disclosure may be any container and may be sealable or non-sealable. The chamber or bin of the present disclosure may be made of any material to hold fruit. For example, a chamber or bin may be made of plastic, wood, glass, or any other semipermeable or impermeable material. An exemplary bin or chamber of the present disclosure includes, but is not limited to, a wagon, a transport truck cargo area, a cold-storage room, a marine container, an air container, a train car or local vehicle, a transport truck or trailer, a box, a pallet-wrap, a greenhouse, a grain silo, or similar.

The bin or chamber may be of any size that is large enough to hold plants or crops to be treated. For example, an exemplary chamber or bin may have a volume or capacity of about 50 to about 2000 pounds (lbs.), from about 150 lbs. to about 1750 lbs., from about 300 lbs. to about 1500 lbs., from about 500 lbs. to about 1250 lbs., from about 750 lbs. to about 1100 lbs., from about 800 lbs. to about 1000 lbs., from about 850 lbs. to about 1000 lbs., and at about 900 lbs. or about 950 lbs.

Liquid treatments may comprise commercially available 1-MCP products. For example, an exemplary commercially available 1-MCP product is AFxRD-038, which has 3.8% active ingredient. In exemplary liquid 1-MCP treatments, about 25 grams (g) to about 50 g of AFxRD-038 may be used. Other 1-MCP products, such as AFx701w or AFx701, may also be used in the present disclosure. In fact, two or more 1-MCP products may be combined to prepare yet a further embodiment of the 1-MCP treatment described herein. For example, a 1-MCP treatment comprising a combination of AFxRD-038, AFx701w, and/or AFx701 may be used in the treatment of the present disclosure.

Liquid treatment of the present disclosure may comprise from about 25 g to about 45 g, from about 25 g to about 42 g, from about 25 g to about 41 g, from about 26 g to about 40 g, from about 27 g to about 39 g, from about 28 g to about 38 g, from about 29 g to about 37 g, from about 30 g to about 36 g, from about 31 g to about 36 g, and at about 30 g, 31 g, 32 g, 33 g, 34 g, 35 g, or 36 g of AFxRD-038 product. Liquid treatments of AFx701 may also range from 10 g to 80 g of formulation, which represents about 0.13 g to about 1.04 g of active 1-MCP ingredient per 0.85 m³ (cubic meters) of fruit. For example, the liquid AFx701 treatment may comprise from about 10 g to about 75 g, from about 15 g to about 70 g, from about 20 g to about 65 g, from about 25 g to about 60 g, from about 30 g to about 55 g, from about 35 g to about 50 g, and from about 40 g to about 45 g, and at about 10 g, 15 g, 20 g, 30 g, 40 g, 50 g, 60 g, 70 g, and 80 g of AFx701 product.

In addition, the liquid treatment formulation of the present disclosure may comprise about 0.10 g to about 1.05 g, from about 0.15 g to about 1.0 g, from about 0.20 g to about 0.95 g, from about 0.25 g to about 0.90 g, from about 0.30 to about 0.80 g, from about 0.35 g to about 0.75 g, from about 0.4 g to about 0.7 g, from about 0.45 g to about 0.65 g, from about 0.50 to about 0.60 g, and at about 0.10 g, 0.13 g, 0.15 g, 0.20 g, 0.25 g, 0.30 g, 0.35 g, 0.40 g, 0.45 g, 0.50 g, 0.55 g, 0.60 g, 0.65 g, 0.70 g, 0.75 g, 0.80 g, 0.85 g, 0.90 g, 0.95 g, 1.0 g, and 1.04 g, and 1.05 g of 1-MCP active ingredient.

Liquid 1-MCP treatments may be applied to the plants or crops at a rate that is reported as the volume (gallons or gal) of active ingredient (i.e., 1-MCP compound) per chamber or bin. For example, the rate that the 1-MCP treatment of the present disclosure may be effectively applied to plants or fruits may range from about 0.1 gal to about 10 gal per bin of fruit. Thus, the rate of the total volume of 1-MCP in a liquid treatment may range from about 0.1 gal to about 9 gal, from about 0.1 gal to about 8 gal, from about 0.1 gal to about 7 gal, from about 0.1 gal to about 6 gal, from about 0.1 gal to about 5 gal, from about 0.1 gal to about 4 gal, from about 0.1 gal to about 3 gal, from about 0.1 gal to about 2 gal, from about 0.1 gal to about 1 gal, from about 0.3 gal to about 8 gal, from about 0.1 gal to about 0.4 gal, from about 0.25 gal to about 10 gal, from about 0.25 gal to about 8 gal, from about 0.25 gal to about 6 gal, from about 0.25 gal to about 4 gal, from about 0.25 gal to about 3 gal, from about 0.5 gal to about 3 gal, from about 0.5 gal to about 2 gal, from about 0.5 gal to about 1 gal, from about 0.5 gal to about 4 gal, from about 0.5 gal to about 5 gal, and at about 0.5 gal, about 1 gal, about 2 gal, about 3 gal, about 4 gal, about 5 gal, and about 5 gals per bin or chamber of fruit. For smaller bins of fruit, about 10 L or less, about 8 L or less, about 6 L or less, about 5 L of less, about 4 L or less, about 3 L or less, about 2 L or less, and about 1 L or less of 1-MCP treatment per bin of fruit may be used.

In addition, the AFx701 formulation of 1-MCP may be applied to fruit via an injection, which requires only a small volume of the treatment formulation. For example, about 5 ml to about 75 mls of liquid AFx701 formulation may be diluted with about 1 liter to about 4 liters of water. More specifically, about 10 mls to about 70 mls, from about 15 mls to about 65 mls, from about 20 mls to about 60 mls, from about 25 mls to about 55 mls, from about 30 mls to about 50 mls, from about 35 mls to about 45 mls of AFx701 formulation may be mixed with about 1.5 liters to about 3.5 liters, from about 2 liters to about 3 liters and at about 2.5 liters of water to make the treatment formulation of the present disclosure.

Further, a rate of about 100 gal to about 500 gals of 1-MCP treatment may be applied per acre of fruit crops. For example, about 100 gal to about 400 gal, from about 200 gal to about 350 gal, from about 250 gal to about 300 gal, from about 300 gal to about 400 gal, and at about 100 gal, 200 gal, 300 gal, 400 gal, and about 500 gal of 1-MCP treatment per acre of fruit crops may be used in the present disclosure.

Any plants and plant parts, such as agronomic crops or horticultural crops, may be treated using the present method. In addition, plants and agricultural crops in any production cycle may be used in the method of the present application. For example, plants and crops in greenhouse production, post-harvest during field packing, palletization, in-box, during storage, and throughout the distribution network.

Furthermore, the 1-MCP compound treatment of the present disclosure is not recycled. Therefore, the compositions and methods of the present disclosure provide no opportunity to spread infection from diseased and/or infected fruit to non-diseased and/or uninfected fruit via the treatment process. Thus, the compounds and methods of the present exposure are advantageous to prevent or reduce disease spread in fruit crops, which is particularly beneficial to small growers who cannot economically afford to lose crops due to disease infection. Accordingly, the present method is more economically feasible to small growers.

Economic benefit is also rendered to the user of the present methods which only require small quantities of horticultural plants and crops to treat with compositions of 1-MCP. More specifically, the present disclosure provides methods for treating post-harvest fruit crops with a liquid composition of 1-MCP in order to protect the plants or fruit crops from premature ripening prior to storage or transport. Thus, the reduced amount of plants or crops to be treated makes the present method economically feasible to small farmers, growers, and producers.

The present disclosure demonstrates that a quick post-harvest liquid treatment application of a ripening inhibitor, such as 1-MCP, overcomes the degradation to the plants or fruit crops during the time delay of treatment that typically occurs between harvest and treatment. For example, timing of the ripening inhibitor treatment via the present method overcomes any degradation or detriment to the plant or fruit crops that occurs in the time period between harvest and treatment of the plant or fruit crops where the plant or fruit crops are not treated with a ripening inhibitor treatment. As exemplified in the present disclosure, plant or fruit crops that are treated with the ripening inhibitor treatment of the present method experience inhibited ripening, minimal detriment, and have reduced degradation as compared to plants or fruit crops that are not treated with the pending method.

### Device for Administering 1-MCP Compounds

The present disclosure is directed to a wand device (14) for inhibiting the ripening process of plants and crops, particularly fruit crops. For example, 1-MCP treatments may be administered to fruit crops using a wand device (14) to aid uniform application of a ripening inhibitor treatment or formulation, such as Harvista AFxRD038 or AFx701, to the fruit. The wand device (14) specifically controls how uniformly the ripening inhibitor treatment formulation is applied to fruit.

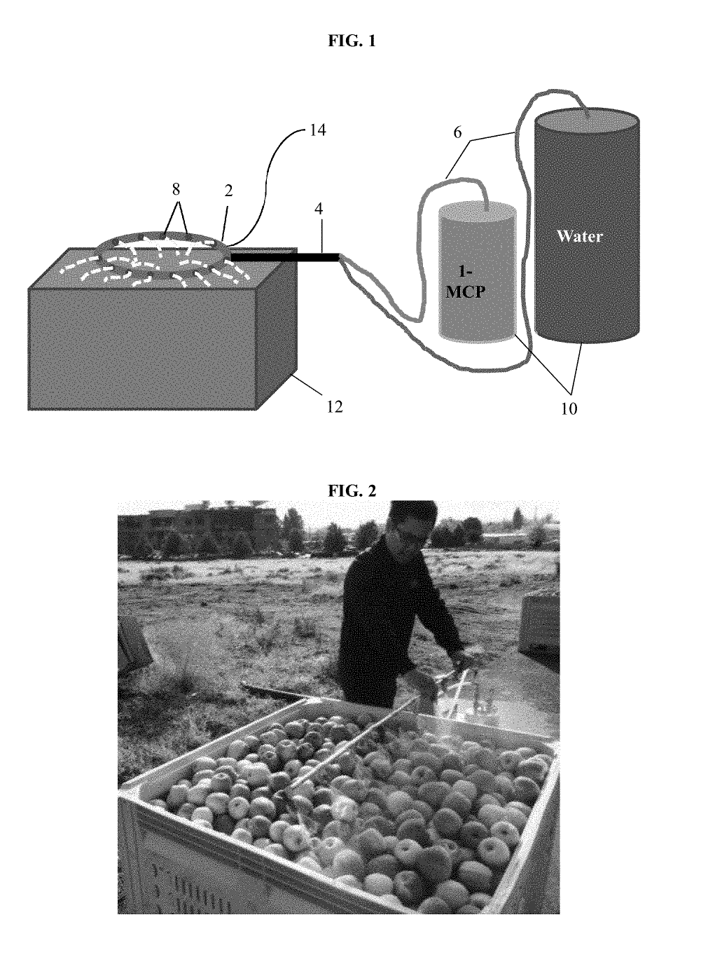

In one embodiment of the present disclosure (see FIG. 1), the wand device (14) may be manually held by an operator to apply the ripening inhibitor treatment to fruit located in a bin or chamber (12). For example, the wand device (14) may be connected to a backpack comprising a ripening inhibitor treatment formulation to allow for mobile application of the treatment to fruits in the field or outside. In another embodiment of the present disclosure, the wand device (14) may be held by a piece of stationary equipment or an instrument under which fruit (12) is passed in order to apply the ripening inhibitor treatment to fruit. For example, the wand device (14) may be stationarily held by equipment in a warehouse or loading zone for treatment application to fruit (12). In this embodiment, fruit (12) may be placed under the wand device (14) to allow application of the ripening inhibitor treatment to the fruit. FIG. 1 demonstrates an illustrative stationary embodiment of the wand device, wherein a bin of fruit (12) is placed under the wand device (14) or a truck comprising fruit (12) may be driven under or through the wand device (14) for uniform ripening inhibitor treatment of the fruit (12).

The wand device (14) of the present disclosure is comprised of, consists of, or consists essentially of multiple components, including, but not limited to a sprayer (2), a shaft (4), and a hose (6; see FIG. 1). The sprayer (2), the shaft (4), and the hose (6) each comprise an internal duct (or open tube; not shown) through which the treatment formulation flows. The duct may comprise a diameter ranging from approximately 1 mm to 6 mm, from about 2 mm to about 5 mm, from about 3 mm to about 4 mm, and often about 5mm.

The sprayer (2), located at the proximal end of the wand device (14), is connected to the shaft (4), which connects to the hose (6) located at the distal end of the wand device (14; see FIG. 1). In another embodiment of the wand device (14), there may be a plurality (i.e., one or more) of the sprayers (2), the shafts (4), or the hoses (6).

The sprayer (2) of the wand device (14) may have a shape that is circular (see FIG. 1) or straight (see FIG. 2). For example, the circular sprayer (2) may comprise a diameter that ranges from approximately 6 inches to about 4 feet in diameter, from about 6 inches to about 3 feet, from about 6 inches to about 2 feet, from about 1 foot to about 4 feet, from about 1 foot to about 3 feet, and from about 1 foot to about 2 feet, and at about 6 inches, 1 foot, 2 feet, and 3 feet in diameter. The straight sprayer (2) embodiment may have a length of approximately 2 feet to about 10 feet, and is often about 2 feet, about 3 feet, about 4 feet, about 5 feet, about 6 feet, about 7 feet, about 8 feet, about 9 feet, and about 10 feet in length.

The sprayer (2) also comprises orifices (8) and/or nozzles (8) through which the treatment formulation exits the sprayer (2) and is applied to the fruit (see FIG. 1). The orifices (8) and/or nozzles (8) are located around the circumference of a single side of the sprayer (2). Typically, a sprayer (2) may comprise from about 4 to about 20, from about 6 to about 18, from about 8 to about 15, from about 10 to about 14, and right at about 6, 8, 10, 14, 15, 18, and or 20 orifices (8) or nozzles (8). Distance between each orifice (8) or nozzle (8) on the sprayer (2) may range from about 1 cm to about 6 cm, and often ranges from about 1 cm to about 4 cm, from about 2 cm to about 3 cm, and at about 3 cm apart. Each orifice (8) or nozzle (8) of the sprayer (2) delivers a certain amount of treatment formulation to the fruit to enable uniform distribution of the treatment formulation to the fruit.

The shaft (4) connects the sprayer (2) to the hose (6). More specifically, the shaft (4) connects the distal end of the sprayer (2) to the proximal end of the hose (6). In the embodiment of the wand device (10) having a circular sprayer (2), the shaft (4) may comprise a length ranging from approximately 2 feet, about 3 feet, about 4 feet, about 5 feet, and about 6 feet, in length.

The hose (6) of the wand device (14) connects the shaft (4) of the wand device (14) to one or more containers (10) or tanks (10) that house the ripening inhibitor formulation or different components of the ripening inhibitor formulation. For example, in one embodiment, the proximal end of the hose (6) is connected to the distal end of the shaft (4) of the wand device (14) while the distal end of the hose (6) is connected to a single tank (10) comprising a ripening inhibitor treatment formulation, wherein the formulation comprises the active ingredient (i.e., 1-MCP), water, and all other components necessary to form the treatment formulation.

In another embodiment, the distal end of the shaft (4) may be connected to the proximal end of a plurality of hoses (6) wherein the distal end of each hose (6) penetrates one of several different tanks (10). Each tank (10) comprises a different component or combination of components of the ripening inhibitor treatment. Each treatment component or combination flows from its tank through its respective hose (6) into the shaft (4). The treatment components are combined in the shaft (4) of the wand device (14) to form the ripening inhibitor treatment which further flows into the sprayer (2) and is applied to the fruit through the orifices (8) of the sprayer (2).

Exemplary embodiments of 1-MCP treatment of the present disclosure that may be conducted using the hose (6) attached to a pressurized water source (not shown). The water may come from a pump attached to a tank (10) or reservoir (10) or from another pressurized water source (not shown). For example, water may flow from a tank (10) pressurized with a carbon dioxide (CO₂) charge. The hose (6) from the water source (not shown) may be interrupted by a fitting or pump (not shown) that facilitates a proportional injection of liquid formulation of active ingredient into the stream of water traveling to the wand device (14). The concentration of formulation in the water stream will be adjusted to achieve the desired efficacy and need for wetting.

### Methods of Administering 1-MCP Compounds

The present disclosure is directed to methods of inhibiting the ripening process of plants and crops, particularly fruit crops. 1-MCP treatments may be applied to the plants or crops inside of a bin or a chamber. The chamber may be open or closed/sealed during application of the 1-MCP treatment. Typically, the plants or crops, such as fruit crops are manually or robotically placed in the chamber, and the chamber may optionally be sealed. The 1-MCP treatment is then applied to the chamber comprising the plants or crops, such as fruit crops.

The chamber may comprise, consist of, or consist essentially of different environments or atmospheres in which the plants or fruit crops are exposed. For example, a chamber may comprise refrigerated temperatures of about 4° C. or lower (e.g., 0° C.). In addition, a chamber may comprise a controlled atmosphere that is flooded with nitrogen (N₂) in order to reduce oxygen (O₂) levels in the chamber. Further, and/or alternatively, the fruit may be exposed to a regular atmosphere, wherein the environment is not controlled. For example, a regular atmosphere typically comprises refrigerated temperatures of about 4° C., and an environment that has about 20% oxygen (O₂), about 78% nitrogen, and about 1% carbon dioxide (CO₂). Finally, fruit may be exposed to warm room days wherein the fruit are removed from the cool temperatures of the controlled and/or regular atmospheres and brought into spaces at room temperature where fruit may be assessed for quality and ripeness.

The 1-MCP treatment is applied to the chamber within an an initial time period. For example, the plants may be exposed to the 1-MCP treatment in the chamber within the initial time period ranging from about 1 minutes to about 5 days (120 hours), from about 2 minutes to about 4 days, from about 3 minutes to about 3 days, and from about 4 minutes to about 2 days, and from about 5 minutes to about 1 day.

The duration of application of the 1-MCP treatment onto the plants or crops may range from about 3 seconds to about 30 minutes. More often, treatment application times range from about 3 seconds to about 1 minute, from about 4 seconds to about 55 seconds, from about 4 seconds to about 50 seconds, from about 4 seconds to about 45 seconds, from about 5 seconds to about 40 seconds, from about 4 seconds to about 35 seconds, from about 4 seconds to about 30 seconds, from about 4 seconds to about 25 seconds, from about 4 seconds to about 20 seconds, from about 4 seconds to about 16 seconds, from about 4 seconds to about 15 seconds, from about 4 seconds to about 10 seconds, from about 4 seconds to about 8 seconds, from about 4 seconds to about 5 seconds, less than 5 seconds, and at about 1 second, 2 seconds, 3 seconds, 4 seconds, 5 seconds, 8 seconds, 10 seconds, 16 seconds, and 50 seconds.

The temperature of the chamber during the initial time period may remain at room temperature, which ranges from about 20° C. to about 25° C. These temperatures may be as high as about 35° C., for example, if fruit is coming from the field. After fruit treatment with 1-MCP for the initial time period, the fruit may be dried. For example, the fruit may be air dried or dried at room temperature or warmer. In addition, the fruit may be dried inside the chamber, in a confined space, or outside.

After the initial time period in which the treatment is exposed to the fruit in the chamber, the fruit may then be stored for a secondary time period. For example, the fruit may be stored for the secondary time period ranging from about 12 hours to about 5 days (120 hours), from about 1 day to about 4 days, and from about 2 days to about 3 days. The temperature of fruit storage during the secondary time period may be at room temperature or warmer.

After expiration of the secondary time period, the treated fruit may be moved and/or stored for a third time period. For example, the fruit may be stored for the third time period ranging from about 12 hours to about 90 days, from about 1 day to about 85 days, from about 2 days to about 75 days, from about 7 days to about 60 days, from about 10 days to about 45 days, from about 14 days to about 30 days, from about 21 days to about 30 days, and for about 30 days, 33 days, 45 days, 60 days, or 90 days. The cold air temperature of fruit storage during the third time period ranges from about 2° C. to about 10° C., from about 2° C. to about 8° C., from about 2° C. to about 6° C., from about 2° C. to about 4° C., and at about 4° C. Alternatively, the temperature of the chamber during the third time period may remain at room temperature.

After expiration of the third time period, the treated fruit may be moved and/or stored for a fourth time period. For example, the fruit may be stored for the fourth time period ranging from about 12 hours to about 15 days, from about 1 day to about 14 days, from about 2 days to about 13 days, from about 3 days to about 12 days, from about 4 days to about 11 days, from about 5 days to about 10 days, from about 5 days to about 8 days, 6 days to about 9 days, and for about 5 days, 6 days or 7 days. The temperature of the fruit storage during the fourth time period may be at room temperature or warmer, depending on the temperatures associated with the storage operator capabilities.

At the expiration of the fourth time period, each chamber or bin of fruit may be uniformly sampled by removing about 100 to about 400 fruits, and preferably about 250 fruits, from the top of each bin, layer by layer. Each layer of fruits are then stored in a sampling container. The sampling containers may be made of plastic, or any other material.

The fruits in the sampling containers may be stored for a fifth time period. For example, the fruit may be stored for the fifth time period ranging from about 12 hours to about 20 days, from about 1 day to about 19 days, from about 2 days to about 18 days, from about 3 days to about 16 days, from about 4 days to about 15 days, from about 5 days to about 15 days, from about 6 days to about 14 days, from about 7 days to about 14 days, and for about 6 days, 7 days, 10 days, and/or 14 days. The temperature of the fruit storage during the fifth time period may be at room temperature or warmer.

At the expiration of the fifth time period, inhibition of plant ripening on the stored fruit may be assessed, evaluated, and compared to a control sample where no 1-MCP treatment was administered or different treatment conditions were applied. In particular, a subset of fruits from each layer of each storage bin may be analyzed for firmness, ethylene content, and/or fruit skin color.

An illustrative method of the present disclosure comprises a quick liquid treatment of 1-MCP to treat fruit in a pre-harvest and post-harvest setting. Comparative data generated in the present disclosure indicate that the method of the present disclosure required significantly less active 1-MCP ingredient than conventional methods of pre-harvest fruit treatments, and comparable amounts of 1-MCP as used in conventional post-harvest fruit treatments. In fact, the presently disclosed method has been shown to require only 0.20 grams (g) of 1-MCP per bin of fruit as compared to 3.1 g of Harvista AFxRD038 and 0.92 g of Harvista AFx701 used for pre-harvest treatment of a fruit bin, and 0.003 g of SmartFresh 1-MCP treatment used for post-harvest treatment of a fruit bin. The present method may also be applied to small quantities of pre-harvest fruit (e.g., less than 900 lbs. of fruit per bin or less than 250 fruit per layer) in the field.

### EXAMPLES

Illustrative embodiments of the methods of the present disclosure are provided herein by way of examples. While the concepts and technology of the present disclosure are susceptible to broad application, various modifications, and alternative forms, specific embodiments will be described here in detail. It should be understood, however, that there is no intent to limit the concepts of the present disclosure to the particular forms disclosed, but on the contrary, the intention is to cover all modifications, equivalents, and alternatives consistent with the present disclosure and the appended claims. The following experiments were used to determine the effect of different concentrations of 1-MCP administered fruits in order to delay ripening of the fruits due to ethylene production and/or exposure.

### Example 1

### Liquid 1-MCP Drench Treatment on Pears

This experiment was conducted to test the effect of 1-MCP treatment on Bartlett pears.

Bins of freshly harvested Bartlett pears were sprayed with 0 gal (control), 1.0 gal, 2.0 gal, or 3.0 gal of Harvista AFxRD038 formulation. The AFxRD038 liquid 1-methylcyclopropene (1-MCP) formulation was made of 3 gal of water, 36 g of AFxRD038, 113 ml of HiSupreme Spray Oil, and 5.63 ml of Silwett L-77 surfactant.

A CO₂ backpack sprayer was used to apply the different volumes of 1-MCP treatment within an initial time period of a few days (e.g., about 2-3 days). The formulation was applied to bins containing a total of approximately 900 lbs of pears. Each bin comprised 7-9 layers depending on the size of the pears, with layer 1 being the top layer and layers 7-9 being the bottom layer. A control bin having 9 layers of pears was not sprayed with 1-MCP treatment.

The bins of pears were allowed to air dry outside, and were then stored in regular cold air (i.e., about 4° C.) for a second time period of about two days. The fruit was then moved to a controlled atmosphere storage having a temperature of 31° F. for a third time period of about 45 days. Upon removal of the fruit from storage in the bins, the fruit was then placed in a warm room having a temperature of about 68° F. for a fourth time period of about six days.

On the sixth day of the fourth time period of warm room exposure, each individual bin of fruit was sampled in a uniform fashion. Uniform sampling was performed by removing about 250 pears from the top of each bin, layer-by-layer. Each layer of about 250 fruit was stored in plastic bins for further analysis during a fifth time period. Day 6 evaluation occurred on the same day the layers were removed from the bin. Four days later (Day 10), another series of fruit layers were analyzed. Four more days later (Day 14), the last set of fruit from the bins were analyzed.

On days 6, 10, and 14, a subset of fruit from each layer of each bin was analyzed for firmness, ethylene content, and fruit skin color. Quality measurements were taken on an individual layer of fruit within each treated bin to establish the effectiveness and consistency of the treatments from top to bottom of each fruit bin (see FIGS. 3-5). For example, firmness of the pears was measured by peeling the pears, and measuring the middle pulp with an 8 mm tip.

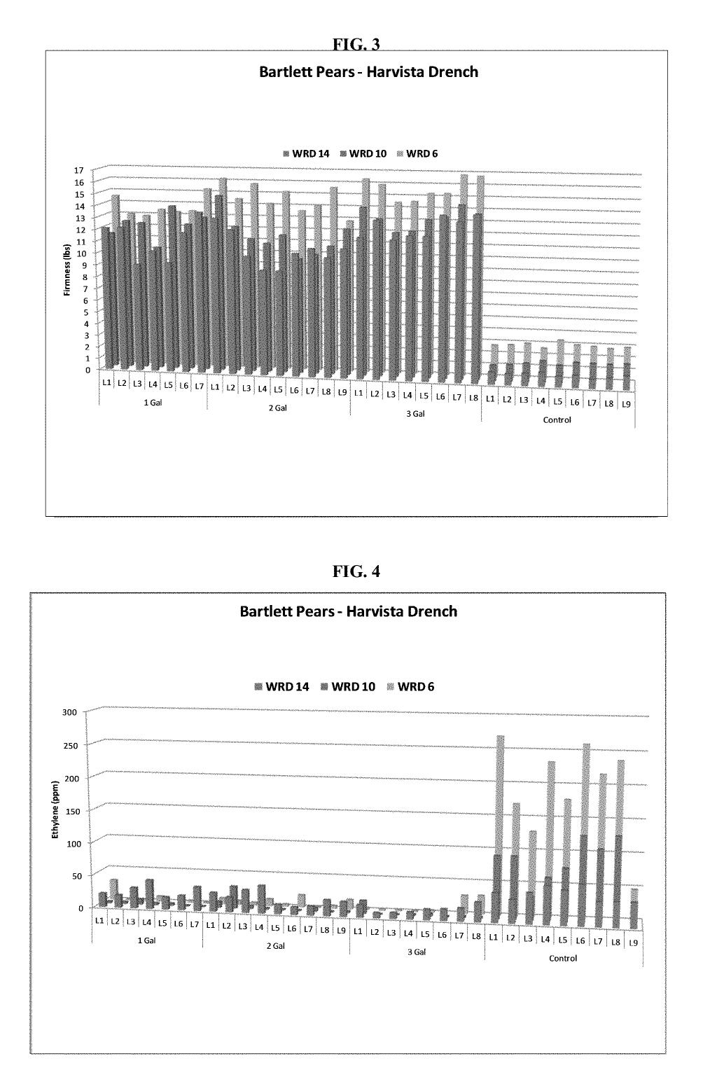

The outcome of this drenching experiment is summarized in FIGS. 3-5 and the corresponding statistical data is shown in Tables 1-5. In FIG. 3, all three 1-MCP treatment concentrations (i.e., 1 gal, 2 gal, or 3 gal) showed significant differences from the control fruit with respect to firmness on warm days 6, 10, and 14. In fact, FIG. 3 demonstrates that fruit sprayed with 1-MCP in layers 1-9 showed significantly better firmness at warm days 6, 10, and 14 than the control fruit that were not sprayed. FIG. 4 demonstrates that fruit sprayed with 1-MCP in layers 1-9 showed significantly lower ethylene concentrations at warm days 6, 10, and 14 than the control fruit that were not sprayed. However, as the number of days increased, the number of significant differences between treated pears and control pears decreased.

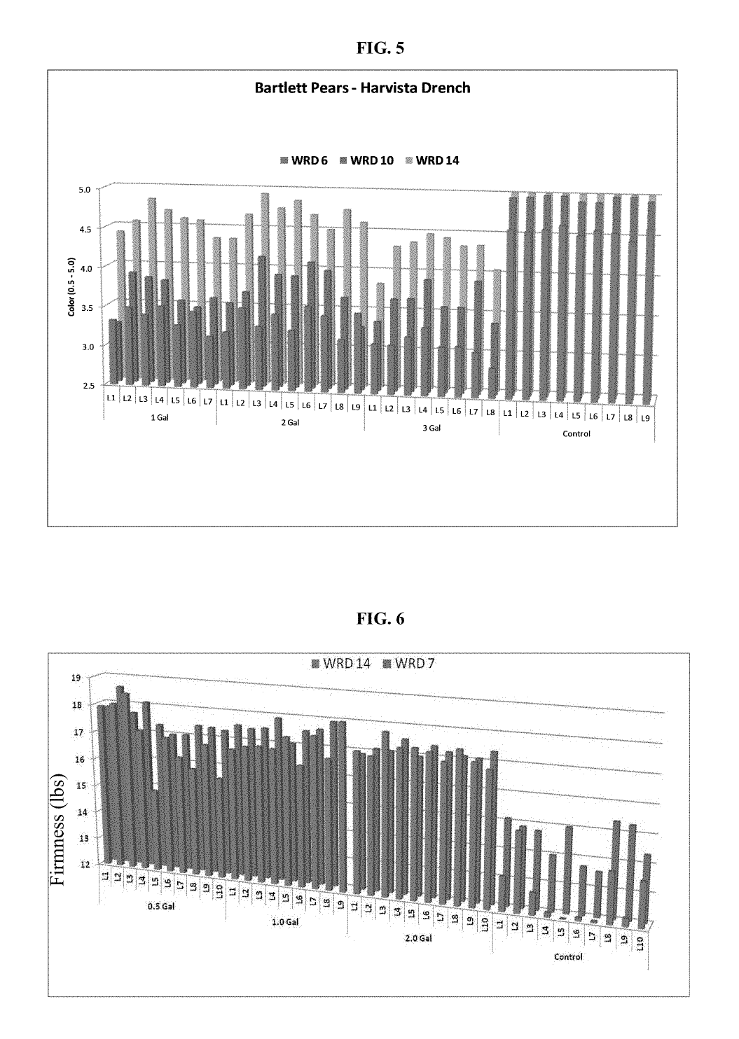

Finally, FIG. 5 demonstrates that fruit sprayed with 1-MCP in layers 1-9 on days 6 and 10 showed significantly less fruit color (indicating less ripening) than the control fruit that were not sprayed. However, by warm day 14, none of the layers showed a significant difference in fruit skin color. Ultimately, FIGS. 3-5 and Tables 1-5 demonstrate that the present method using as little as 1 gal of a 1-MCP treatment is effective to control and/or inhibit fruit ripening in pears.

In Table 1, the layers listed (i.e., “Lx”) are layers that contained fruit that were not statistically significantly different from control. “All” in Table 1 indicates that fruit tested in all layers was statistically significantly different from control, while “none” indicates that no layers were identified that had statistical significance from control.

Table 2 represents the statistical analysis of all fruit within a bin without taking any account for layers of fruit. Thus, a bin-to-bin comparison of treatment is shown in Table 2. Values within each layer and day of warm room treatment shown in Tables 2-5 are not statistically different from each other at the p<0.05 level if followed by the same letter/color.

### Example 2

### Liquid 1-MCP Drench Treatment on Apples

This experiment was conducted to test the effect of 1-MCP treatment on Red Delicious apples. This experiment was performed exactly as detailed above in Example 1 for Bartlett pears, but with a few noted exceptions described here. Specifically, Red Delicious apples were treated with a 1-MCP treatment comprising 31 g of AFxRD038. The apples were treated with 0.5 gal, 1.0 gal, and 2.0 gal volumes of the 1-MCP treatment, which were applied to bins of apples comprised in 9-10 layers depending on the size of the apples. A control bin having 10 layers of apples was not sprayed with 1-MCP treatment. The apples were stored for a third time period at room temperature for 33 days. The apples were analyzed for firmness and ethylene content at warm day 7 and 14 of the fifth time period.

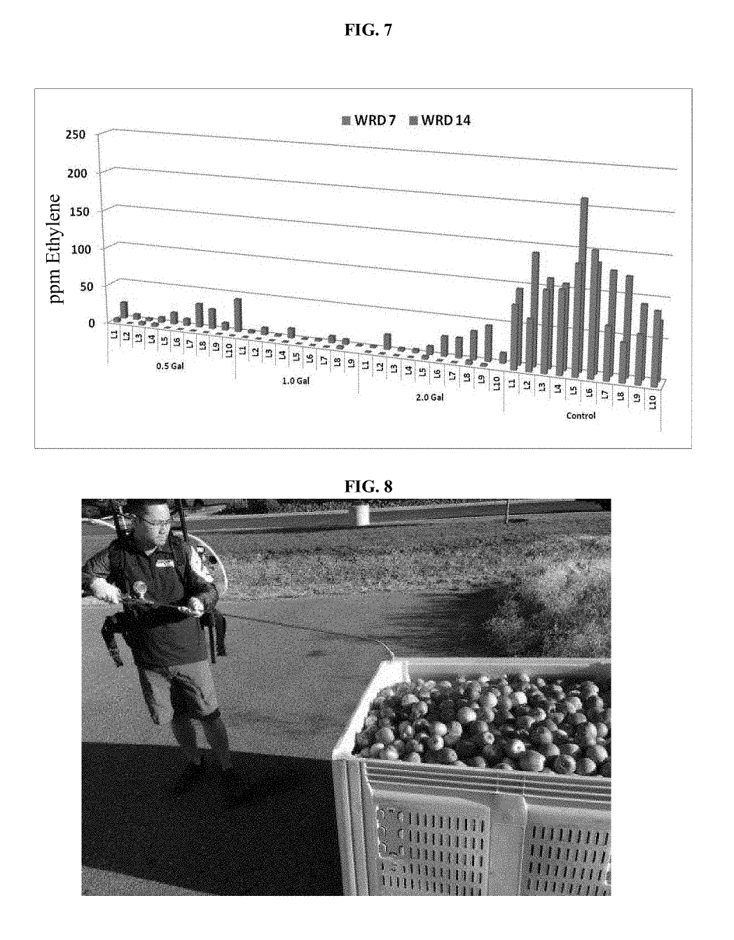

The outcome of this drenching experiment is summarized in FIGS. 6 and 7 and the corresponding statistical data is shown in Tables 6-9. All three treatment concentrations (i.e., 0.5 gal, 1.0 gal, and 2.0 gal) showed differences from the control fruit with respect to firmness and ethylene content. However, FIG. 6 demonstrates that most apples sprayed with 1-MCP showed significantly better firmness at warm day 7 than the control apples that were not sprayed, except for apples in layers 5, 8, and 9. At day 14, most apples sprayed with 1-MCP showed significantly better firmness than the control apples that were not sprayed, except for apples in layers 2, 5, 8, and 10.

FIG. 7 demonstrates that all apples sprayed with 1-MCP in layers 1-10 showed significantly lower ethylene concentrations at warm day 7 than the control apples that were not sprayed. However, only the 1 gal concentration of 1-MCP treatment had similar effects in all apple layers at day 14. Ultimately, FIGS. 6 and 7 and Tables 6-9 demonstrate that the present method using as little as 0.5 gal of a 1-MCP treatment is effective to control and/or inhibit fruit ripening in apples.

In Table 6, the layers listed (i.e., “Lx”) are layers that contained fruit that were not statistically significantly different from control. “All” in Table 6 indicates that fruit tested in all layers was statistically significantly different from control, while “none” indicates that no layers were identified that had statistical significance from control. Additional data regarding this experiment are shown in Tables 7-9 provided herein.

Table 7 represents the statistical analysis of all fruit within a bin without taking any account for layers of fruit. Thus, a bin-to-bin comparison of treatment is shown in Table 7. Values within each layer and day of warm room treatment shown in Tables 7-9 are not statistically different from each other at the p<0.05 level if followed by the same letter/color.

TABLE 1
Statistical Significance between Control and Treated Bins of Pears by Layers

| | WRD 6 | | | WRD 10 | | | WRD 14 | | |
|---|---|---|---|---|---|---|---|---|---|
| 1-MCP Concentration | 1 Gal | 2 Gal | 3 Gal | 1 Gal | 2 Gal | 3 Gal | 1 Gal | 2 Gal | 3 Gal |
| Firmness | All | All | All | All | All | All | All | All | All |
| Ethylene Content | L1 | L 4, 6, and 9 | L 6and 7 | All | L 1, 2, and 9 | L5 | L 1-4, and 7 | L 1-4 and 8-9 | L 1 and 7-9 |
| Skin Color | All | All | All | All | All | All | None | None | None |

TABLE 6
Statistical Significance between Control and Treated Bins of Apples by Layers

| | WRD 7 | | | WRD 14 | | |
|---|---|---|---|---|---|---|
| 1-MCP Concentration | 0.5 Gal | 1 Gal | 2 Gal | 0.5 Gal | 2 Gal | 3 Gal |
| Firmness | L 8 and 9 | L 5 | L 1, 5, and 8-9 | L 2, 5, 8, and 10 | L 1, 2, and 8 | L 2 and 10 |
| Ethylene Content | All | All | All | L 1-4, and 7 | All | L 1 and 7-9 |

### Example 3

### Comparative Liquid 1-MCP Spray Treatment on Melons

This experiment was conducted to test the effect of 1-MCP spray treatment on Cantaloupe melons as compared to SmartFresh treatment. Bins containing 9 kilograms each of freshly harvested Cantaloupe melons were sprayed four times using a dual-liquid sprayer comprising the Harvista AFx701 formulation (see FIG. 10). Each spray of the AFx701 liquid 1-methylcyclopropene (1-MCP) formulation comprised 83.5 mg of AFx701 and 608 mg of water. Thus, a total amount of 1.67 mg of 1-MCP active ingredient and 2.43 g of water was applied to each bin of melons, which equates to 0.185 mg of 1-MCP per kg of melons. The 1-MCP treatment formulations were prepared and applied to apples using a sprayer, and compared to apples that had been treated with SmartFresh or no 1-MCP at all (control).

The bins of melons were allowed to air dry outside, and were then stored in regular cold air (i.e., about 36° F.) for a second time period of about 15 days. The melons were then moved to a regular atmosphere storage having a temperature of about 70° F. for a third time period of about 2, 4, or 6 more days. Upon removal of the fruit from storage in the bins, the fruit were then analyzed for firmness. Firmness of the melons was measured by cutting the melons in half, and measuring the middle pulp with an 8 mm tip.

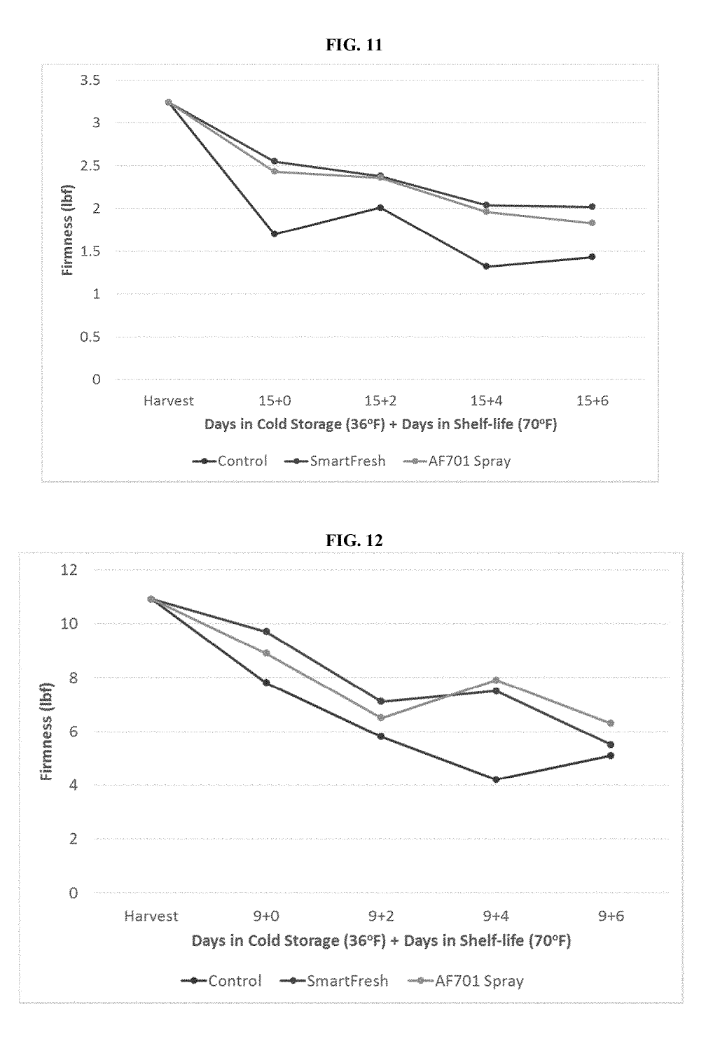

Day 15 evaluation occurred on the same day the fruit were removed from storage in the bin. Two days later (Day 15+2), another series of fruit were analyzed. Two more days later (Day 15+4), an additional set of fruit were removed and analyzed. Finally, the last set of fruit from the bins was analyzed two days later (Day 15+6). Quality measurements were taken on individual melons randomly selected from different treated bins and different positions within each treated bin (e.g., the edge and/or the center of the bin) to establish the effectiveness and consistency of the treatments (see FIG. 11).

The outcome of this spray experiment is summarized in FIG. 11 and the corresponding statistical data is shown in Table 10. In FIG. 10, the 1-MCP spray treatment concentrations showed significant differences from the control fruit with respect to firmness on all days. In addition, FIG. 11 demonstrates that the firmness of fruit sprayed with 1-MCP was relatively comparable to melons treated with SmartFresh on all days. Ultimately, FIG. 11 and Table 10 demonstrate that the present method using a 1-MCP spray treatment is effective to control and/or inhibit fruit ripening in melons.

Table 10 represents the statistical analysis of a bin-to-bin comparison of 1-MCP treatment. Values shown in Table 10 are not statistically different from each other at the p<0.05 level if followed by the same letter/color.

### Example 4

### Comparative Liquid 1-MCP Spray Treatment on Melons

This experiment was conducted to test the effect of 1-MCP spray treatment on Cantaloupe melons as compared to SmartFresh treatment. This experiment was performed exactly as detailed above in Example 1 for Bartlett pears, but with a few noted exceptions described here. The bins of melons were allowed to air dry outside, and were then stored in regular cold air (i.e., about 36° F.) for a second time period of about 9 days. The melons were then moved to a regular atmosphere storage having a temperature of about 70° F. for a third time period of about 2, 4, or 6 more days. Upon removal of the fruit from storage in the bins, the fruit were then analyzed for firmness. Firmness of the melons was measured by cutting the melons in half, and measuring the middle pulp with an 8 mm tip.

The outcome of this spray experiment is summarized in FIG. 12 and the corresponding data is shown in Table 11. In FIG. 12, the 1-MCP spray treatment concentrations showed significant differences from the control, but were statistically the same as SmartFresh treated fruit with respect to firmness on all days. In addition, FIG. 12 demonstrates that the firmness of melons sprayed with 1-MCP was even higher on Day 9+4 as compared to melons treated with SmartFresh. Ultimately, FIG. 12 and Table 11 demonstrate that the present method using a 1-MCP spray treatment is effective to control and/or inhibit fruit ripening in melons.

Table 11 represents the statistical analysis of a bin-to-bin comparison of 1-MCP treatment. Values shown in Table 11 are not statistically different from each other at the p<0.05 level if followed by the same letter/color.

### Example 5

### Comparative Analysis of 1-MCP Treatments of Apples

This experiment was conducted to test the effect of different application methods of 1-MCP treatment (i.e., Harvista AFx701) on Golden Delicious apples in bins. Apples were treated with two different formulations of the 1-MCP treatment, including a formulation comprising 1) 20 grams of 1-MCP and 2 liters of water, which was applied in 10 seconds and 2) 60 grams of 1-MCP and 6 liters of water, which was applied in 30 seconds. The 1-MCP treatment formulations were prepared and applied to apples using the wand device, and compared to apples that had been treated with SmartFresh or no 1-MCP at all (control).

Apples were stored for 65 days in cold air at about 1° C. temperature, prior to being stressed for 7 days at room temperature. Replicates of 25 fruit were sampled from each layer of each fruit bin to analyze fruit firmness (in pounds, lbs) and internal ethylene concentration (ppm). Data were analyzed on a whole bin basis using all replicates from each layer.

The outcome of this experiment and the corresponding statistical data is shown in Table 12. Fruit firmness was highest in the apples treated using the wand device with 1-MCP Treatments 1 and 2 (described above) over SmartFresh and control apples. However, apples treated with SmartFresh still showed significantly less ethylene concentration than apples treated with 1-MCP Treatments 1 and 2. In addition, apples treated with 1-MCP Treatment 2 showed significantly less ethylene concentration than apples treated with Treatment 1 or not at all (control).

Thus, Table 12 demonstrates that the present method using a wand device to apply a 1-MCP treatment is effective to control and/or inhibit fruit ripening in apples, particularly fruit firmness and ethylene concentration. Values within each layer shown in Table 12 are not statistically different from each other at the p<0.05 level if followed by the same letter/color.

### Example 6

### Comparative Analysis of 1-MCP Treatments of Apples and Pears

This experiment was conducted over two years (i.e., 2014-2015) to test the effect of three different application methods of 1-MCP treatment (i.e., Harvista AFx701) on apple and pear varieties in bins. Bartlett and D′Anjou pear varieties were tested in this experiment along with Gala, Golden Delicious, Red Delicious, Granny Smith, Fuji, and Pink Lady apple varieties. Different formulations of the 1-MCP treatment were prepared and applied to fruit varieties as described in Table 12.

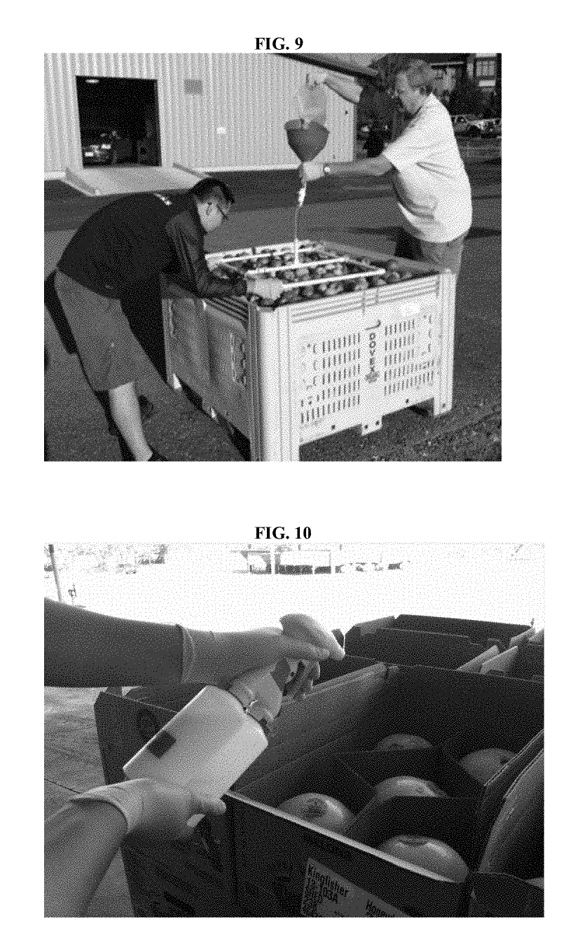

The 1-MCP treatment formulation was applied to the fruit using: 1) a CO2 backpack at 40 psi pressure, an 8006 flat fan nozzle, and an application time to the fruit of 50 seconds (see FIG. 8); 2) a BinBong method comprising a funnel and PVC piping, wherein the 1-MCP and water are mixed for 5 seconds, poured into the funnel, and applied to the fruit for 10 seconds (see FIGS. 9); and 3) a straight wand device (comprising eight nozzles) connected to a Dema injection pump at 25 psi pressure, an 8010 flat fan nozzle, and an application time to the fruit ranging from 4-16 seconds (see FIG. 2).

Experimental details, including grams (g) of 1-MCP active ingredient, volume (L) of water, and application times in seconds (s) are shown in Tables 13-17. All fruit were stored in a regular cold air prior to taking quality measurements. Layers were sampled for all applications. Previous within bin uniformity in SmartFresh data resulted in taking only a random subsample of fruit, not a sampling from layers. BinBong and wand treatments were compared to conventional SmartFresh treatment results.

Statistical data demonstrating the results of the present experiment for the pear varieties are described herein. More specifically, data showing the results of the BinBong method in Bartlett and D'Anjou pear varieties are presented in Tables 18 and 19, respectively. Statistical data demonstrating the results of the BinBong method for the apple varieties are described in detail in Tables 20 and 21.

Additional statistical data for the comparison of fruit in bin layers of this comparative experiment of the method of application of 1-MCP treatments in apples and pear varieties is shown in Tables 22-46. Values within each layer shown in Table 18-46 are not statistically different from each other at the p<0.05 level if followed by the same letter/color.

TABLE 13
Three Methods of 1-MCP Treatment Applied
to Apple and Pear Varieties

| | CO2 | | | | | | | | |
|---|---|---|---|---|---|---|---|---|---|
| AFx701 (1-MCP) | Backpack | BinBong | | | Wand | | | | |
| Concentration (g) | 16.2 | 8.1 | 16.2 | 16.2 | 10 | 20 | 20 | 40 | 80 |
| Water | 2 | 2 | 2 | 2 | 2 | 1 | 2 | 2 | 4 |
| Volume | | | | | | | | | |
| (L) | | | | | | | | | |
| Appli- | 50 | 10 | 10 | 10 | 8 | 4 | 8 | 8 | 16 |
| cation | | | | | | | | | |
| Time | | | | | | | | | |
| (sec) | | | | | | | | | |

TABLE 14
Early 2014 Comparative Method Applications on Fruit

| | App | | | CO2 Backpack | Bin Bong | | |
|---|---|---|---|---|---|---|---|
| Variety | Date | Control | SmartFresh | 16 g AF701 + 2 L | 8 g + 2 L | 16 g + 1 L | 16 g + 2 L |
| Bartlett 1 | 8/21 | X | Bin | X | X | X | X |
| Bartlett 2 | 8/22 | X | Bin | X | X | X | X |
| Gala 1 | 9/5 | X | Bin | X | X | X | X |
| Gala 2 | 9/7 | X | Bin | X | X | X | X |
| Golden 1 | 9/23 | X | Bin | X | X | X | X |
| Golden 2 | 9/30 | X | Bin | X | X | X | X |
| Anjous | 9/29 | X | Bin | X | X | X | X |

TABLE 17
Late 2014 Season Sampling Schedule for Comparative Method Applications on Fruit

| | Treatment | | First | Layers | Second | Layers |
|---|---|---|---|---|---|---|
| Variety - Source | Date | Method | Sample | Measured | Sample | Measured |
| Reds - Ciderworks | Oct. 13, 2014 | Wand | 11/12 - 30 (9*) | 1-9 | 1/12 - 91 (7) | 1-9 |
| Granny Smith - Podlich | Oct. 13, 2014 | Wand | 11/11 - 35 (14) | 1-9 | 1/12 - 91 (14) | 1-9 |
| Fuji - Ciderworks | Oct. 29, 2014 | Wand | 12/3 - 35 (14) | 1-9 | 3/5 - 129 (14) | 1-9 |
| Pink Lady - Wacker | Oct. 29, 2014 | Wand | 12/9 - 41 (14) | 1-9 | 2/19 - 127 (14) | 1-9 |

*Date Removed from RA storage - Days in warm room storage (days stressed prior to analysis)

The preceding description enables others skilled in the art to utilize the technology in various embodiments and with various modifications as are suited to the particular use contemplated. In accordance with the provisions of the patent statutes, the principles and modes of operation of this disclosure have been explained and illustrated in exemplary embodiments. Accordingly, the present invention is not limited to the particular embodiments described and/or exemplified herein.

It is intended that the scope of disclosure of the present technology be defined by the following claims. However, it must be understood that this disclosure may be practiced otherwise than is specifically explained and illustrated without departing from its spirit or scope. It should be understood by those skilled in the art that various alternatives to the embodiments described herein may be employed in practicing the claims without departing from the spirit and scope as defined in the following claims.

The scope of this disclosure should be determined, not only with reference to the above description, but should instead be determined with reference to the appended claims, along with the full scope of equivalents to which such claims are entitled. It is anticipated and intended that future developments will occur in the arts discussed herein, and that the disclosed compositions and methods will be incorporated into such future examples.

Furthermore, all terms used in the claims are intended to be given their broadest reasonable constructions and their ordinary meanings as understood by those skilled in the art unless an explicit indication to the contrary is made herein. In particular, use of the singular articles such as “a,” “the,” “said,” etc. should be read to recite one or more of the indicated elements unless a claim recites an explicit limitation to the contrary. It is intended that the following claims define the scope of the disclosure and that the technology within the scope of these claims and their equivalents be covered thereby. In sum, it should be understood that the disclosure is capable of modification and variation and is limited only by the following claim.

What is claimed is:

1. A method of treating small quantities of plants or plant parts with a ripening inhibitor treatment comprising:
placing the plants or plant parts in a bin,
administering a ripening inhibitor treatment comprising a cyclopropene compound to the plants or plant parts in the bin, and
delaying the ripening of the plants or plant parts.

2. The method of claim 1, wherein the plants or plant parts comprise apples or pears.

3. The method of claim 1, wherein the ripening inhibitor treatment is administered to the bin of plants or plant parts as a liquid composition.

4. The method of claim 3, wherein the ripening inhibitor treatment comprises about 0.5% to about 50% of the cyclopropene compound.

5. The method of claim 1, wherein the cyclopropene compound is 1-methylcyclopropene (1-MCP) or an analog or derivative thereof.

6. The method of claim 5, wherein the 1-MCP or analog or derivative thereof comprises the following structure:

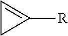

7. The method of claim 6, wherein the R is methyl.

8. The method of claim 1, wherein the ripening inhibitor treatment comprises 0.10 g to 1.05 g of 1-MCP compound.

9. The method of claim 1, wherein the bin is sealed.

10. The method of claim 1, wherein the bin has a volume ranging from about 50 pounds to about 2000 pounds.

11. The method of claim 1, wherein the cyclopropene compound is selected from the group consisting of AFxRD-038, AFx701w, AFx701, and combinations thereof.

12. The method of claim 1, wherein the ripening inhibitor treatment is administered at a rate of about 100 gal/acre to about 500 gal/acre of plants or plant parts.

13. The method of claim 1, wherein the ripening inhibitor treatment is not recycled.

14. The method of claim 1, wherein the method is effective in reducing the spread of infection and disease among the plants or plant parts.

15. The method of claim 1, wherein administering the ripening inhibitor treatment does not require a confined space.

16. A wand device to perform the method of claim 1, wherein the wand device comprises:
one or more sprayers located at the proximal end of the wand device,
one or more hoses located at the distal end of the wand device,
a shaft that connects the one or more sprayers to the one or more hoses, and
the ripening inhibitor treatment.

17. The wand device of claim 16, wherein the shape of the one or more sprayers is circular or straight.

18. The wand device of claim 16, wherein the one or more sprayers comprise one or more orifices through which the ripening inhibitor treatment is released.

19. The wand device of claim 18, wherein the one or more orifices are located around the circumference of a single side of the one or more sprayers.

20. A method of administering a ripening inhibitor treatment to small quantities of plants or plant parts according to the method of claim 1 comprising:
placing the plants or plant parts in the bin for a treatment time period,
wherein the bin has a temperature and an atmosphere to which plants and plant parts are exposed during the treatment time period,
administering a ripening inhibitor treatment comprising 1-MCP to the plants or plant parts in the bin during the treatment time period.
